(19) United States
(12) Patent Application Publication
(10) Pub. No.: US 2018/0270280 A1
(43) Pub. Date: Sep. 20, 2018

(54) CONTENT-SHARING APPLICATION COMBINED WITH SOCIAL MEDIA AND METHOD OF USE

(71) Applicant: Nicholas J. Matzorkis, Austin, TX (US)

(72) Inventor: Nicholas J. Matzorkis, Austin, TX (US)

(21) Appl. No.: 15/925,267

(22) Filed: Mar. 19, 2018

Related U.S. Application Data
(60) Provisional application No. 62/473,244, filed on Mar. 17, 2017.

(51) Int. Cl. H04L 29/06; G06Q 50/00

(52) U.S. Cl. CPC H04L 65/4076; G06Q 50/01; H04L 65/4092

(57) ABSTRACT

A system and method for simultaneously sharing Internet-provided content among multiple users forming user groups. Individual users can select between receiving individualized content and simultaneously receiving content with other connected users. Time codes are provided for synchronizing the content distribution.

### CROSS-REFERENCE TO RELATED APPLICATION

This application claims priority in U.S. Provisional Patent Application No. 62/473,244, filed Mar. 17, 2017, which is incorporated herein by reference.

### BACKGROUND OF THE INVENTION

### 1. Field of the Invention

The present invention relates generally to an application for listening to music via internet-connected devices and a method for use thereof, and more specifically, to an application for synchronized music listening among a group of socially-connected users, and the method of use thereof.

### 2. Description of the Related Art

There are great number and variety of social applications available to users of internet-connected devices (e.g., smart phones, tablets, portable computers, etc.). These applications allow users to connect with family, friends, coworkers, or people from similar social groups to share thoughts, photos and videos.

Heretofore there has not been available an application or method for synchronized content listening among a group of socially-connected users with the advantages and features of the present invention.

### SUMMARY OF THE INVENTION

The present invention generally provides a cross-platform application that allows users to share music and other content they are listening to on Internet-connected devices, allowing an unlimited number of users to simultaneously listen to the same content in real time, regardless of the source. For example, when users log into the application they can either listen to music from sources have available to them, or select music being played by anyone else they are connected to via the application.

In a non-limiting exemplary application, the application invention identifies a song or other content being heard by a first user (e.g., User A) along with a time code in the song. If a second user (e.g., User B) selects the song being played by User A, the song picks up at the same point playing for User B. User B continues to hear whatever User A is hearing for as long as they remain connected to User A's “channel,” or until User A stops listening to music. License fees for the songs playing for all users are paid for by the administrator of the application. The application will integrate advertisements into the live streams for users to cover the cost of the license fees, or if a premium monthly subscription is purchased, ads can be removed for users

### BRIEF DESCRIPTION OF THE DRAWINGS

The drawings constitute a part of this specification and include exemplary embodiments of the present invention illustrating various objects and features thereof.

FIG. 1 is a schematic, block diagram of a content-sharing application combined with social media and embodying an aspect of the present invention.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. Said terminology will include the words specifically mentioned, derivatives thereof and words of similar meaning.

### II. Preferred Embodiment Social Media Music Mobile Application and Method of Use

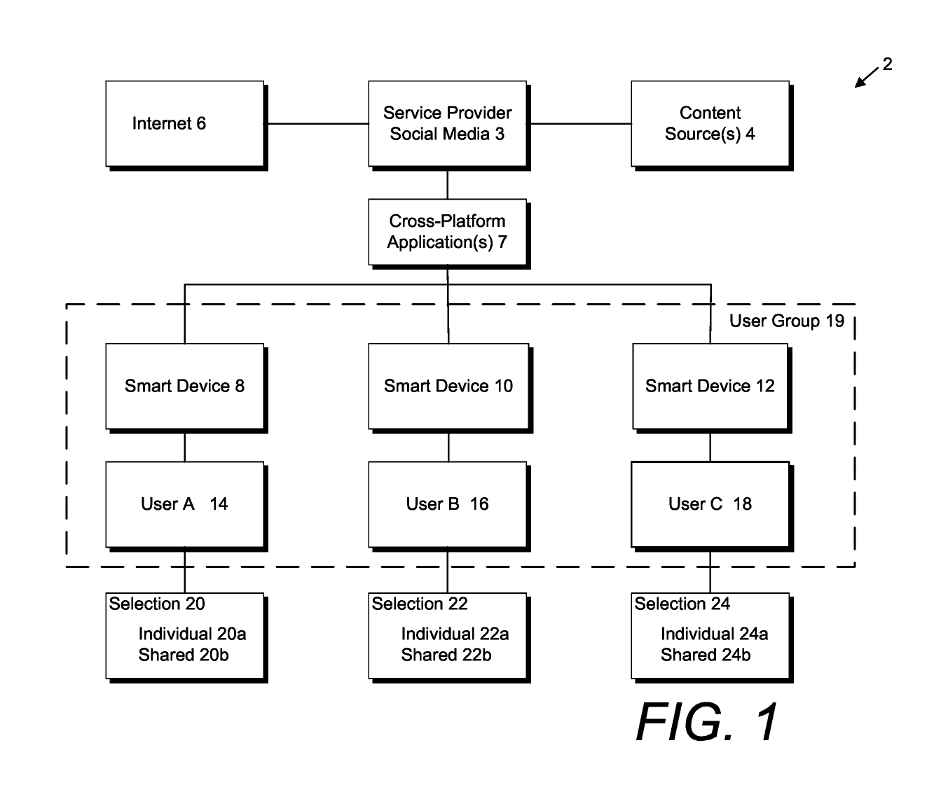

Referring to the drawing in more detail, FIG. 1 shows a content-sharing system 2 embodying an aspect or embodiment of the present invention. The system 2 connects a service provider 3 (e.g., providing social media) with content sources 4 via the Internet 6. For example, the content sources 4 can provide, without limitation, entertainment (e.g., music), information and various other audible content. The service provider 3 can connect to multiple cross-platform applications 7, which can be downloaded onto multiple smart devices, e.g., 8, 10, 12. The smart devices 8, 10, 12 are associated with users A, B, C, which are designated in FIG. 1 with reference numerals 14, 16, 18, collectively designated as a user group 19. It will be appreciated that the numbers of smart devices and users are virtually unlimited. For example, user groups 19 can be formed with large numbers of participants at various, widely-separated geographic locations. Of course, small user groups in close proximity to each other are equally feasible with the present invention.

Upon downloading a cross-platform mobile application 7, e.g., from an application store, users 14, 16, 18 will register the application software within the mobile application or in a browser via the application host website. The users 14, 16, 18 will then create a profile which will allow themselves to be found by other users of the application for the purposes of creating user (e.g., social, professional, educational, etc.) groups 19 within the applications 7. The users 14, 16, 18 can make selections 20, 22, 24, respectively. The selections 20, 22, 24 can comprise individual selections 20a, 22a, 24a, respectively, or shared selections 20b, 22b, 24b, respectively.

Several options exist for creating social and other user groups 19 within the applications 7. Users can connect with other users by submitting requests (e.g. “buddy” or “friend”) with one another. Such requests notify other potential users that someone wishes to connect with them, and typically provide “accept” and “deny” options. Accepting the request adds the users to their respective lists of connections within the application and enables interaction therebetween.

Alternatively, a user may simply follow another application user (“unreciprocated buddy”) which will allow the initial user to view another's music use activity but will not allow further interaction within the mobile application.

Also alternatively, a user may add a connection within the application by sending a text message or e-mail message to a known application user with a “sync link” which, when clicked by the receiving user, connects the sending user and the receiving user as buddies (friends) within the application and simultaneously plays the audio music track sent for both the sender and the receiver.

Upon opening the mobile application, the user can scroll through all of their inter-application connections who are currently also logged into the mobile application and who are listening to content. Inter-application connection user names are displayed, along with a content identifier, e.g., the name and artist of a song that a user is currently listening to. The timestamp of the current song and the name of the album on which the song appears are also displayed for each active “buddy” listening to the chosen song. Users can scroll through their list of inter-application connections, select and click any active inter-application “buddy” to begin listening to the music, with the song timing synchronized with the “buddy” selected.

If multiple inter-application connected users are already listening in sync (simultaneously), the user names of those connections are grouped together, along with the song track info in the list of active mobile application connections they are currently listening to. When a new user joins a synchronized user group, others already listening to that content receive a notification from the application by default that a new user has joined. When a user is listening in sync to an inter-applications connection's song, when the connection's player goes to the next song, the music continues in sync for the user listening in sync to the previous song, and so on.

The sync will end when the user either leaves the playlist of the person they are syncing with or the person playing the music stops playing music. At this time, the user listening would start hearing music based on their default settings or they select another inter-application connection to sync with. If a user does not select an active inter-application connection or connections to synchronize with, that user may select any track from the catalog of music available within the application by search through bands, songs, artists, playlists, etc., which then becomes available to synch with to and is added inter-application connections of that user.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A system for simultaneously sharing content from an Internet service provider with multiple users comprising a user group, which system comprises:
a smart device associated with each user;
an application loaded on the smart device and configured for simultaneously sharing the content; and
said application including an option configured for enabling a user to select between individually-selected content and connection to a user group.

2. The system of claim 1, which includes:
cross-platform applications loaded on said smart devices.

3. The system of claim 1, which includes:
time codes associated with said content for use by said applications in synchronizing the content being received by said users.

4. The system of claim 1, which includes:
said applications being configured for user purchase of premium, commercial-free content providing service.

5. The system of claim 1 wherein the Internet service provider provides a social media service to users.

6. The system of claim 1 wherein the smart device comprises a mobile telecommunications device.

7. The system of claim 1 wherein the smart device comprises a computer.

8. The system of claim 1 wherein said content comprises music.

9. The system of claim 1 wherein said content comprises information.

10. The system of claim 1 wherein said content includes audio and video components.

11. A method of simultaneously sharing content among multiple users of smart devices, which comprises the steps of:
providing an Internet service provider;
connecting the smart devices of the multiple users to said Internet service provider; and
enabling said users to choose between receiving individually-selected content and connection to a user group.

12. The method of claim 11, which includes the additional step of loading cross-platform applications on said smart devices.

13. The method of claim 11, which includes the additional step of associating time codes with said content for use by said applications in synchronizing the content being received by the users.

14. The method of claim 11, which includes the additional step of configuring said applications for user purchase of premium, commercial-free content providing services.

15. The method of claim 11, which includes the additional step of notifying user groups receiving synchronized content when a new user joins the group.

16. The method of claim 11, which includes the additional steps of, after a first content distribution stops, enabling a user to either: continuing receiving content from said user's default settings; or selecting another inter-application connection to receive synchronized content from.
